(19) United States
(12) Patent Application Publication
(10) Pub. No.: US 2009/0195085 A1
(43) Pub. Date: Aug. 6, 2009

(54) ALTERNATING CURRENT POWER SOURCE

(76) Inventor: Peter D. Joseph, Twin Lakes, WI (US)

Correspondence Address: BRINKS HOFER GILSON & LIONE, P.O. BOX 10395, CHICAGO, IL, 60610, US

(21) Appl. No.: 12/334,617

(22) Filed: Dec. 15, 2008

Related U.S. Application Data
(60) Provisional application No. 61/026,299, filed on Feb. 5, 2008.

(51) Int. Cl. G05F 3/02

(52) U.S. Cl. 307/151

(57) ABSTRACT

A power source, such as a device for providing electrical power to operate other devices, is provided. The power source includes an input voltage connection in communication with a low voltage line of a low voltage lighting system and circuitry operative to convert a voltage of the input voltage connection to an output voltage of at least 90 VAC. The power source also includes an output voltage connection for communicating the output voltage to a peripheral outside of the housing.

### RELATED APPLICATIONS

This application claims priority under 35 U.S.C §119(e) to U.S. Provisional Patent Application No. 61/026,299 filed on Feb. 5, 2008, which is hereby incorporated by reference in its entirety.

### BACKGROUND

Many devices require power or electrical energy to operate. For example, some devices include a power plug that plugs into a wall socket or a 110 alternating current voltage (“VAC”) outlet. Desired locations of operating such devices may differ. For example, operating fans, radios, small televisions, fountains, or other devices in a front or back yard of a homeowner's property or any other outdoor environment may be desirable.

### BRIEF SUMMARY

In one aspect, a power source is provided. The power source includes an outlet including a housing. A converting device is within the housing. The converting device is provided for connecting with a low voltage line. The converting device converts a voltage provided by the low voltage line to substantially at least 90 alternating current volts RMS. The outlet is used to output the substantially at least 90 alternating current volts RMS.

Other systems, methods, features and advantages of the design will be, or will become, apparent to one with skill in the art upon examination of the following figures and detailed description. It is intended that all such additional systems, methods, features and advantages be included within this description.

### BRIEF DESCRIPTION OF THE DRAWINGS

The components in the figures are not necessarily to scale, emphasis instead being placed upon illustrating the principles of the design. Moreover, in the figures, like referenced numerals designate corresponding parts throughout the different views.

FIG. 1 is a perspective view of a low voltage system;

FIG. 2 is a block diagram illustrating a component of a power source of the low voltage system of FIG. 1;

FIG. 3 is a circuit schematic of the power source of FIG. 2;

FIG. 4 is an alternate circuit schematic of the power source of FIG. 2; and

FIG. 5 is a flowchart illustrating a method for providing power.

### DETAILED DESCRIPTION

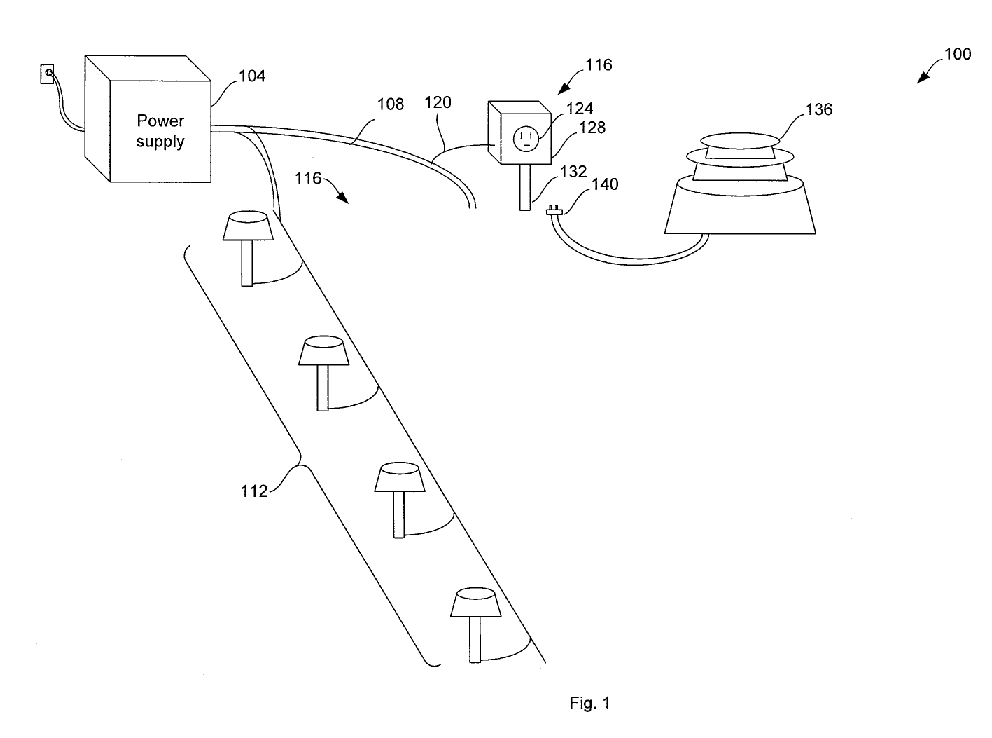

FIG. 1 is a perspective view of a low voltage system 100. The system 100 is an outdoor light system or other system that produces a low voltage to power and/or operate devices. For example, the system 100 is a low voltage outdoor lighting system. The system 100 includes, but is not limited to, a power supply 104, a power supply line 108, one or more remote devices 112, a power source 116, and a connecting device 120. Fewer, more, or different components or devices may be provided. The system 100 may be used to illuminate lights and/or control, power, or operate other remote devices. The lights and/or other remote devices may be placed in a garden area or may illuminate or operate near a driveway or pathway or other surroundings.

The power supply 104 is used to supply power to the remote devices 112 via the power supply line 108. For example, the power supply 104 is a low voltage power supply that electrically connects with a standard wall outlet or other high voltage outlet that provides a 110 alternating current volts (“VAC”) at 60 Hz. The power supply 104 converts the 110 VAC to at most 15 VAC RMS, such as 12 VAC, to power the remote devices 112. The power supply 104 may include timers, photo sensors, and/or a switch to turn the power supply on or off. Also, the power supply 104 may generate an encoded signal to power and communicate with the remote devices 112, such as described in U.S. provisional application No. 61/026,282, filed on Feb. 5, 2008, and also U.S. patent application Ser. No. ______ filed on even date herewith, both of which are entitled “POWER LINE COMMUNICATION,” and are both hereby incorporated by reference.

The remote devices 112 are lights, such as outdoor lights, a low power strip, fan, radio, light, or other device that is powered by a low voltage, such as 12 volts. For example, the remote devices 112 are outdoor lights that may be placed in a driveway or pathway of a homeowner's yard or other property. The remote devices 112 may include a processor or other circuitry to operate (such as turning on or off or changing a brightness level) based on signals or data transmitted by the power supply 104. The remote devices 112 connect with the power supply line 108 using a connector. The connector has two pins that penetrate a cover of the power supply line 108 and electrically connect with internal conductors. Alternatively, other connectors may be used.

The power source 116 also connects with the power supply line 108 via a connection 120. The connection 120 is a wire or cable that includes a connector. The connector has two pins that penetrate a cover of the power supply line 108 and electrically connect with internal conductors. Alternatively, other connectors may be used. The connection 120 supplies the low voltage, such as the 12 VAC, to the power source 116.

A structure of the power source 116 includes, but is not limited to, a housing 128, and outlet 124, and a support 132. Fewer, more, or different components may be provided. The housing 128 is made of conductive and/or non-conductive material. The housing 128 has a substantially square or rectangular shape. Alternatively, other geometrical shapes may be used.

The housing 128 is supported by or includes the support 132. The support 132 is made of metal, plastic, or other material. The support 132 may include a base to position the power source on a surface, or the support 132 may be placed beneath a surface, such as a ground of an outdoor environment.

The outlet 124 includes or is supported by the housing 128. The outlet 124 is made of plastic and includes two or three slots for connecting with a power plug. The outlet 124 may be a standard or conventional power outlet. Alternatively, the outlet 124 may be made of other non-conductive material and/or conductive material, and the outlet 124 may have more or less slots for connecting with a power plug. Also, a plurality of outlets 124 may be positioned in a vertical, horizontal, circular, or other pattern in or on the housing 128. The power source 116 converts the low voltage on the power supply line 108 to substantially 90 to 132 VAC RMS, such as at least 90 VAC RMS or 110 VAC RMS at 60 Hz. The at least 90 VAC RMS may be provided to another device, such as the connecting device 136, via the outlet 124. Alternatively, the power source 116 may convert the low voltage on the power supply line 108 to voltages suitable for regions, such as Europe, that utilize substantially 220 VAC RMS at 50 HZ.

The connecting device 136 is a fountain, fan, radio, television, or other device that operates or is powered by 110 VAC. The connecting device 136 may be designed to operate in an outdoor environment. For example, the connecting device 136 is an outdoor or garden fountain. The connecting device 136 includes a power plug 140 that can plug into a power outlet, such as the outlet 124.

The power source 116 is moveable or transferrable. For example, a user may position the power source 116 in any desired location, such as a garden or outdoor area. Therefore, instead of using an extension cable or routing 110 VAC from a house or other structure, the power source 116 can connect to the existing low voltage power supply line 108 and provide at least 90 VAC RMS or 110 VAC RMS to devices, such as the connecting device 136, in a convenient and a pleasant aesthetic manner.

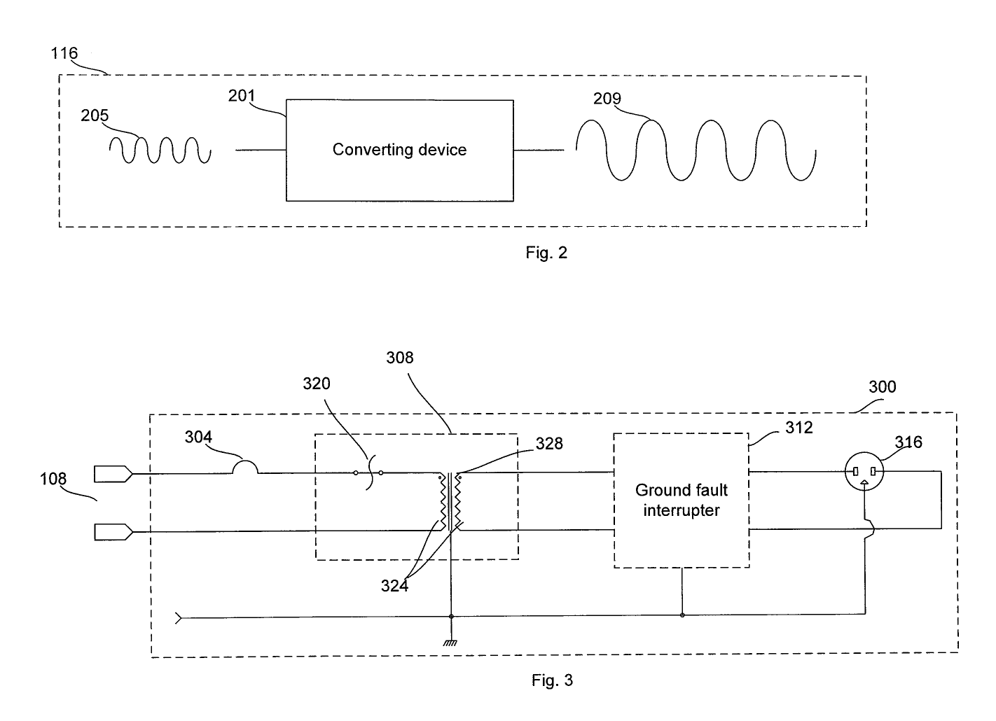

FIG. 2 is a block diagram illustrating a component of the power source 116. For example, the power source 116 includes a converting device 201. Fewer, more, or different components may be provided. For example, the power source 116 may include an electrical and/or mechanical switch, a circuit breaker, ground fault interrupter (“GFI”) components, a processor, safety monitoring circuits, rectifier circuits, and/or other components.

The converting device 201 is a step-up transformer, an inverter circuit, or another device configured to convert a low voltage to a higher voltage, such as a higher alternating current voltage. For example, the converting device 201 receives a signal 205 at an input. The signal 205 is a low voltage alternating current, such as the 12 volts on the power supply line 108 provided by the power supply 104. The converting device 201 converts the signal 205 into a signal 209 or uses the signal 205 to generate the signal 209. The signal 209 is a higher alternating current voltage, such as at least 90 VAC RMS or 110 VAC RMS. The higher voltage is provided to the connections of the outlet 124.

Alternatively, the signal 205 may be a low voltage direct current (“DC”) signal. Or, the signal 205 may be an alternating signal with a substantially square wave form instead of a sinusoidal form. The signal 205 may be encoded to communicate with circuitry or logic of the power source 116.

FIG. 3 is a circuit schematic of a power source 300. The power source 300 is similar to the power source 116. The power source 300 includes a circuit breaker 304, a transformer 308, a ground fault interrupter (“GFI”) 312, and an outlet 316. Fewer, more, or different components may be provided.

The power source 300 connects with the power supply line 108 via a connector, such as a connector that has two pins that penetrate a cover of the power supply line 108 and electrically connect with internal conductors and/or another connector. The circuit breaker 304 is coupled with the power supply line 108. The circuit breaker 304 is a device that disconnects a circuit from a power source if there is an over voltage and/or over current on the line. For example, if the power source 300 experiences a short or draws too much current, the circuit breaker 304 will activate or trip to electrically disconnect from the power supply line 108.

The transformer 308 is connected with the power supply line 108 and/or the circuit breaker 304. For example, the transformer 308 is a step-up transformer. The transformer 308 includes a thermal fuse 320, coils 324, and a core 328. The coils 324 are wrapped or twisted around the core 328 to generate magnetic flux in the core 324 and generate a higher output voltage. For example, the 12 VAC from the power supply line 108 is stepped up to about at least 90 VAC RMS or 110 VAC RMS. The core 328 is an iron core, an air core, or other medium. The thermal fuse 320 is used as a safety feature. For example, if an overvoltage and/or over current occurs, the thermal fuse 320 breaks or disconnects the coils 324 from the power supply line 108. The disconnection may occur based on a temperature level or trigger of the thermal fuse 320. Alternatively, the transformer 308 does not include the thermal fuse 320.

The GFI 312 is coupled with the output of the transformer 308. The GFI 312 is a residual current device, appliance leakage current interrupter, or other device that disconnects a circuit whenever it detects that the flow of current is not balanced between a positive or phase (“hot”) conductor and a neutral conductor, such as positive and neutral conductors of the outlet 316. Such imbalance may be caused by current leakage. The GFI 312 is configured to electrically disconnect the power supply line 108 quickly to substantially reduce harm to a user from potential shocks. Other circuitry other than a GFI may be used to accomplish similar goals or functions. In alternate embodiments, the GFI 312 may not be needed and protection may come by way of the voltage isolation provided by the transformer 328.

The outlet 316, which is similar to the outlet 124, is connected with the GFI 312. For example, a positive or phase conductor and a negative conductor of the outlet 316 is coupled with the power supply line 108 via the GFI 312. A third ground conductor of the outlet 316 is connected with a ground screw 332. The ground screw 332 may connect with a housing, such as the housing 128, which electrically connects to a common or earth ground 336. The outlet 316 may have fewer or more conductors. The conductors are configured to receive a plug from a connecting device, such as the connecting device 136, and to provide at least 90 VAC RMS or 110 VAC RMS.

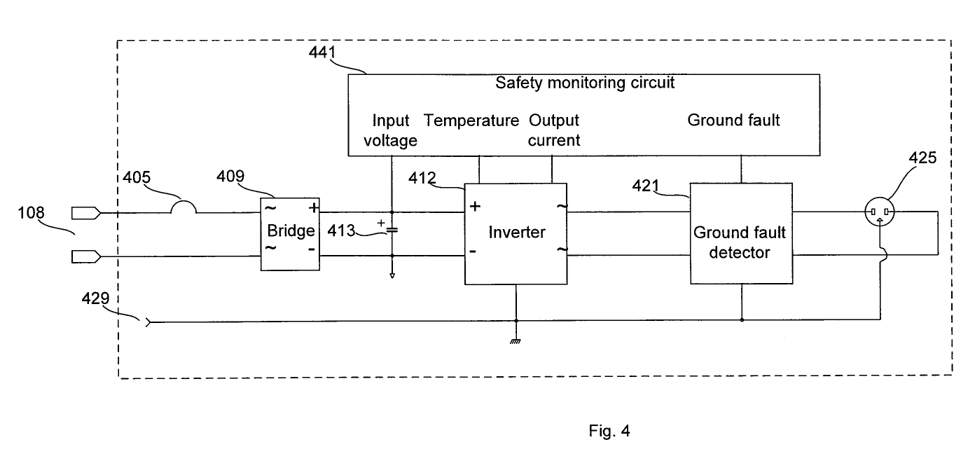

FIG. 4 is a circuit schematic of a power source 401. The power source 401 is similar to the power source 116. The power source 401 includes a circuit breaker 405, a bridge circuit 409, a capacitor 413, an inverter 417, a ground fault detector 421, an outlet 425, and one or more safety monitoring circuits 441. Fewer, more, or different components may be provided.

The power source 401 connects with the power supply line 108 via a connector, such as a connector that has two pins that penetrate a cover of the power supply line 108 and electrically connect with internal conductors and/or another connector. The circuit breaker 405 is similar to the circuit breaker 304.

The bridge circuit 409 is connected with the power supply line 108 and/or the circuit breaker 405. The bridge circuit 409 rectifies an alternating current voltage. For example, the bridge circuit 409 rectifies the 12 VAC on the power supply line 108. The bridge circuit 409 may include one or more diodes. Alternatively, other rectifier circuits may be used. The rectified signal is provided to the capacitor 413. The capacitor 413 has a capacitance value of about 4700 μF. Other capacitance values may be used. The capacitor 413 smoothens the rectified signal to provide a substantially DC signal.

The DC signal is provided to the inverter 417. The inverter 417 steps up or increases the DC level and converts the increased DC voltage to an alternating current voltage, such as at least 90 VAC RMS or 110 VAC RMS. The inverter includes a linear regulator or other device to increase the DC voltage and switches, such as transistors, or other components to generate an AC voltage from the increased DC voltage. The output AC signal is provided to the ground fault detector 421.

The ground fault detector 421 detects or senses ground fault errors similar to the GFI 312. The ground fault detector 421 may be a physical detector or GFI or may be implemented by circuitry such as the safety monitoring circuit(s). The ground fault detector 421 is configured send signals for electrical disconnection of the inverter 417 or the outlet 425.

The outlet 421, which is similar to the outlet 124 or 316, is connected with the ground fault detector 421 and/or the inverter 417. For example, a positive or phase conductor and a negative conductor of the outlet 421 is coupled with the supply power line 108 via the ground fault detector 421 and/or the inverter 417. A third ground conductor of the outlet 425 is connected with a ground screw 429. The ground screw 429 may connect with a housing, such as the housing 128, or shield, which electrically connects to a common or earth ground 433. The outlet 425 may have fewer or more conductors. The conductors are configured to receive a plug from a connecting device, such as the connecting device 136, and to provide at least 90 VAC RMS or 110 VAC RMS.

The safety monitoring circuit(s) 441 includes a voltage detector, a current detector, a temperature sensor, or other detection or sensor devices. For example, an input voltage at the input of the inverter 417 is monitored by a voltage detector, a temperature of the inverter 417 is monitored by a temperature sensor, an output current of the inverter 417 is monitored by a current detector, and/or the ground fault detector 421 is also monitored by the safety monitoring circuit(s) 441. The individual sensor or detection circuits sense an over voltage, current, or temperature during operation of the power source 401, and the circuitry of the power source 401 is electrically disconnected from the power supply line 108 based on detection of values above one or more predetermined thresholds.

The electrical disconnection is implemented by using disconnect switches or fuses or a GFI. All of the sensors, detectors, and/or safety circuits may be integrated on one or more circuit boards. Alternatively, separate circuits are used.

Alternatively, the safety monitoring circuit(s) 441 is implemented by a processor. The processor is a general processor, application-specific integrated circuit (“ASIC”), digital signal processor, field programmable gate array (“FPGA”), digital circuit, analog circuit, or combinations thereof. The processor is one or more processors operable to control and/or communicate with the various electronics and logic of the power source 401. For example, the processor receives input signals from the various components of the power source 401. The processor correlates the input signals with predetermined values, such as by using a look-up-table, to determine whether or not to electrically disconnect circuitry from the power supply line 108 for safety. The processor may send a signal to a switch or other device for disconnection.

Alternatively, the processor is configured to read or process data that may be encoded in the low voltage signal provided by the power supply line 108. The processor may read a bit sequence from the power supply signal and perform an action corresponding to the bit sequence. For example, a bit sequence or other data communication encoded in the power signal may command the processor to electrically disconnect or shut down the power source 401, and the processor disconnects circuitry or powers down the power source 401 based on the encoded data.

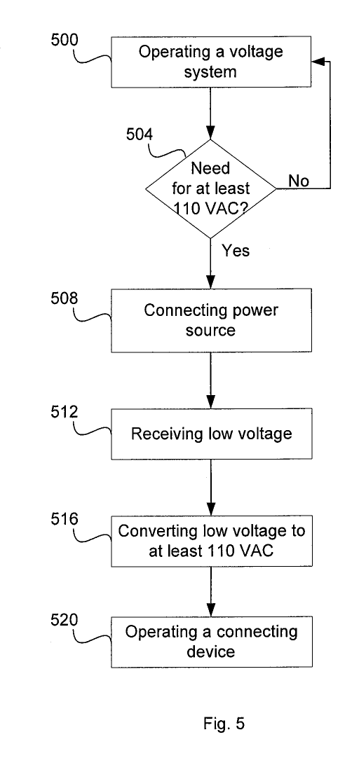

FIG. 5 illustrates a method for providing power. Fewer, more, or different acts or blocks may be provided. A voltage system, such as the system 100, is operated, as in block 500. For example, a user or homeowner turns on or allows for operation of a low voltage system, such as an outdoor lighting system. The system provides a low voltage power signal, such as a 12 VAC, via a power supply line, such as the power supply line 108. The low voltage power signal provides power or operates remote devices, such as the remote devices 112. For example, the remote devices are outdoor lights. The outdoor lights may be placed in a garden area or may illuminate a driveway or pathway or other surroundings.

In block 504, a need or desire for at least 90 VAC RMS or 110 VAC RMS is determined. For example, if the user does not want or need to use at least 90 VAC RMS or 110 VAC RMS to power a device, then the low voltage system may continue to operate as is or may be turned off. However, if the user does want or need to use at least 90 VAC RMS or 110 VAC RMS to operate a device, such as the connecting device 136, then, as in block 508, a power source, such as the power source 116, 300, or 401, is connected with the low voltage system.

For example, the user may want to operate a fountain or other device requiring 110 VAC in a garden area or other outdoor setting. The user connects the power source to the power supply line 108 via a connector, as previously mentioned. The power source may be movable or transferable in the outdoor environment to be place close to a connecting device.

The outdoor lights or remote devices may be manually turned off while the power supply, such as the power supply 104, is on. Alternatively, the power supply may encode the low voltage signal on the power supply line 108 to command the remotes devices or lights to turn off.

In block 512, the power source receives the low voltage power signal from the power supply line. The low voltage signal is converted, as in block 516, to a higher AC signal, such as at least 90 VAC RMS or 110 VAC RMS by the power source, as discussed in regards to FIGS. 2, 3, and 4. For example, the low voltage signal is stepped up to 110 VAC via a transformer. Alternatively, the low voltage signal is rectified and smoothened into a DC voltage, and the DC voltage is increased to a higher DC voltage and converted to the 110 VAC, such as by an inverter. Safety circuitry may be used, such as a GFI, to disconnect the power source from the power supply line to avoid harm to a user or surroundings.

A connecting device, such as the connecting device 136, is operated by plugging it in or connecting it with the power source. For example, a fountain in a garden area or other outdoor areas may plug into an outlet of the power source to receive the at least 90 VAC RMS or 110 VAC RMS. Therefore, a connecting device requiring 110 VAC may be operated in a convenient manner using the existing low voltage system.

Other features described above may be used for additional or other methods of use. Also, the features, components, and/or structures described above may be organized or identified in one or more methods of manufacture.

The logic, software or instructions for implementing the processes, methods and/or techniques discussed above may be provided on computer-readable a non-volatile memory, such as an EEPROM or Flash memory. The functions, acts or tasks illustrated in the figures or described herein are executed in response to one or more sets of logic or instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like.

It is intended that the foregoing detailed description be regarded as illustrative rather than limiting, and that it be understood that the following claims, including all equivalents, are intended to define the scope of this design.

I claim:

1. A voltage converter housing comprising:
an input voltage connection in communication with a low voltage line of a low voltage lighting system;
circuitry operative to convert a voltage of the input voltage connection to an output voltage of at least 90 VAC; and
a output voltage connection for communicating the output voltage to a peripheral outside of the housing.

2. The voltage converter housing according to claim 1, wherein the output voltage connection includes first and second contacts for communicating the output voltage to the peripherals.

3. The voltage converter housing according to claim 2, wherein the output voltage connection includes a third contact for providing an electrical path to the ground for the peripheral.

4. The voltage converter housing according to claim 1, wherein the voltage converter housing is adapted for outdoor use.

5. The voltage converter housing according to claim 1, further comprising a step-up transformer.

6. The voltage converter housing according to claim 5, wherein the step-up transformer enables electrically isolating the input voltage connection from the output voltage connection.

7. The voltage converter housing according to claim 5, wherein the step-up transformer includes a thermal fuse.

8. The voltage converter housing according to claim 1, further comprising an inverter operable to convert a DC voltage into an AC voltage.

9. The voltage converter housing according to claim 8, further comprising a ground fault interruption circuit for preventing communication of the output voltage under a fault condition.

10. The voltage converter housing according to claim 1, wherein safety montitoring circuitry that includes at least one of: over voltage circuitry, under voltage circuitry, over current circuitry, under current circuitry, and a temperature sensor operable to prevent the communication of the output voltage under a fault condition.

11. The voltage converter housing according to claim 1, further comprising a fuse.

12. The voltage converter housing according to claim 1, wherein the output voltage is converted to substantially 110 VAC RMS at 60 Hz.

13. The voltage converter housing according to claim 1, wherein the output voltage is converted to substantially 220 VAC RMS at 60 Hz.

14. The voltage converter housing according to claim 1, wherein the output voltage is converted to substantially 110 VAC RMS at 50 Hz.

15. The voltage converter housing according to claim 1, wherein the output voltage is converted to substantially 220 VAC RMS at 60 Hz.
